(19) United States
(12) Patent Application Publication
(10) Pub. No.: US 2018/0262510 A1
(43) Pub. Date: Sep. 13, 2018

(54) CATEGORIZED AUTHORIZATION MODELS FOR GRAPHICAL DATASETS

(71) Applicant: Microsoft Technology Licensing, LLC, Redmond, WA (US)

(72) Inventor: Congyong Su, Sammamish, WA (US)

(73) Assignee: Microsoft Technology Licensing, LLC, Redmond, WA (US)

(21) Appl. No.: 15/456,176

(22) Filed: Mar. 10, 2017

(51) Int. Cl. H04L 29/06

(52) U.S. Cl. CPC H04L 63/102; H04L 63/101; H04L 63/0442; H04L 63/061

(57) ABSTRACT

In non-limiting examples of the present disclosure, systems, methods and devices for providing access to one or more nodes associated with a shared graphical dataset are provided. In one example, a request to access a resource associated with a shared graphical dataset may be received. A determination may be made as to whether an authorization element for the resource provides one or more access types for the resource based on the request. Access may be provided to the resource for each of the one or more access types that the authorization element is determined to provide access to. In another example, a caller application may request user permission information from a shared graphical dataset. The user permission information may be received and a token comprising one or more authorized access types that the user has for the graphical dataset may be generated and provided back to the graphical dataset.

### BACKGROUND

Large datasets, such as those that are hosted by cloud-based application databases and related processing devices, provide authentication criteria and resource access according to user credentials. The users and user credentials associated with accessing resources via such databases change regularly to account for users being added or dropped from accounts, as well as the access types that are associated with users of those accounts.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Non-limiting examples of the present disclosure describe systems, methods and devices for providing access to one or more nodes associated with a shared graphical dataset. Mechanisms are provided for processing resource requests and authenticating those requests. Examples provide for internal and external authorization of resource requests on a shared application database graph associated with one or more nodal datasets. Authentication mechanisms utilizing internal authentication are provided whereby an application database may receive an incoming request, the incoming request may be matched against authorization criteria for a requested resource, and an authorization access token may be sent to a corresponding nodal dataset. Authentication mechanisms utilizing external authentication are provided whereby an identity provider may request permission information for a nodal dataset, that information may be provided to an application database, and an authentication token may be generated if a requesting user has requisite authentication credentials matching the permission information. The authentication token may be provided to a nodal dataset associated with a requested resource, and an access type for that resource may be granted accordingly.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following Figures.

FIG. 1 illustrates an overview of an example system for providing access to one or more nodes associated with a shared graphical dataset.

FIG. 2 illustrates an exemplary environment for Set creation from multiple entities having multiple resources.

FIG. 3A illustrates an example isolated collection of asserted resource identifiers and corresponding relationships.

FIGS. 3B-3E illustrate an example query model that may be used to traverse a collection of nodes within a Set.

FIG. 4 illustrates an exemplary distributed computing environment for authenticating one or more access types for one or more nodes associated with a shared graphical dataset.

FIG. 5 is an exemplary diagram for performing internal authentication of a request to access one or more resources associated with a shared graphical dataset and one or more nodes representing the one or more resources.

FIG. 6 is an exemplary diagram for performing external authentication of a request to access one or more resources associated with a shared graphical dataset and one or more nodes representing the one or more resources.

FIG. 7A is an exemplary method for performing internal authentication of a request to access one or more resources associated with a shared graphical dataset and one or more nodes representing the one or more resources.

FIG. 7B is an exemplary method for performing external authentication of a request to access one or more resources associated with a shared graphical dataset and one or more nodes representing the one or more resources.

FIG. 8 illustrates a computing device for executing one more aspects of the present disclosure.

FIG. 9 is a simplified block diagram of a computing device with which aspects of the present disclosure may be practiced.

FIG. 10 is a block diagram illustrating physical components (e.g., hardware) of a computing device 1000 with which aspects of the present disclosure may be practiced.

FIG. 11 is a schematic diagram illustrating an example distributed computing environment for authenticating one or more access types for one or more nodes associated with a shared graphical dataset.

### DETAILED DESCRIPTION

Various aspects of the disclosure are described more fully below with reference to the accompanying drawings, which form a part hereof, and which show specific exemplary aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

The present disclosure provides systems, methods, and devices for providing access to one or more nodes associated with a shared graphical dataset. According to examples, one or more application databases may host a plurality of resources (e.g., documents, websites, audio files, images, video files, etc.) as they relate to resources input into those databases and/or resources created and/or edited in association with those databases. For example, the one or more application databases may provide storage for various resource types, as well as cloud-based resource creation and editing capabilities, various user communication services (e.g., meeting hosting, instant messaging services, voice communication services, etc.), cloud-based calendar hosting, etc. Authorization to access resources hosted by such databases may be provided based on tenant credentials for a particular subset of those resources, user identification criteria associated with a particular subset of those resources, and the type of access granted based on those criteria may be provided on a “role-type” basis. That is, upon determining that a particular user may access a resource hosted on an application database, a further determination may be made as to whether the user has read only access, read and write access, and/or execution access for that particular resource and/or a set of related resources.

According to examples, it may be desirable to evaluate one or more resources of one or more application databases and generate one or more Sets composed of nodes that represent the attributes of the evaluated resources. For example, generation of one or more Sets for such resources may provide mechanisms that enable processing of query types that would not be capable of being performed on the resources as stored and/or indexed in an application database. Thus, a data-first database generated through evaluation and indexing of a plurality of resources from one or more application databases may be generated to graphically represent those resources and relationships amongst those resources through node creation, property analysis, and attribute assignment.

According to examples, resources input into a Set generation system may be contextually analyzed and determinations may be made regarding the resources' properties, such as associated party properties, locational properties, temporal properties, topical properties, and associated task properties, among others. Each resource, or portions of each resource (e.g., pages of a website, portions of a document, etc.), may be represented in one or more Set databases as one or more nodes in a tree-like structures, and the determined properties of those resources may be associated with those nodes as node attributes.

Upon generating one or more Sets corresponding to resources in one or more application databases, it may be desirable to provide access to the resources associated with those Sets according to the authorization criteria that controls access to the resources as hosted by the corresponding application databases. That is, if one or more users have access, and an access type, to a resource in the application database, it may be desirable to provide the same access, and access type, to that resource when the user is accessing it by way of a corresponding Set that represents that resource. However, as one or more user groups for a particular tenant of an application database are modified (e.g., users are added and removed from a group, access permissions are modified for a group, etc.), scalability issues arise with regard to duplicating those access credentials across both the application databases and the Sets that represent the resources in those application databases. As such, systems, methods, and devices are provided herein for categorizing resources in one or more application databases such that the Sets that represent those resources are accessible to users based on the authorization criteria for those resources in application databases.

According to examples, a set of resources hosted on one or more application databases may be categorized as being private, shared, or public. For a private set of resources, those resources may be designated as only being available to the creation owner, and that information may be associated with a Set that represents the private group of resources. Public resources may be designated as being accessible to anyone within a natural boundary (i.e., a tenancy boundary), and that information may be associated with a Set that represents the public group of resources. Alternatively, for shared resources, where scalability issues arise with regard to duplicating access credentials across both the application databases and the Sets that represent the resources in those application databases, internal and external authorization mechanisms may be implemented according to aspects of the current disclosure.

According to an example, internal authorization to access one or more resources associated with a Set may comprise one or more of the following elements. A request to access one or more resources of a Set may be received by an application database corresponding to that Set. For example, a request to access one or more resources may be received by an application database via a resource container link. The request may comprise an access token comprising one or more of the following: a unique user identifier for the user making the request, one or more unique resource identifiers corresponding to the one or more resources that the user is attempting to access, an authorization identifier, and a clearance level associated with the user for one or more resources hosted by the application database.

The access token may be received by one or more resource containers hosted by the application database, and determinations may be made regarding the user's authorized access types as they relate to the one or more resources that the user is attempting to access. For example, each resource container may be associated with a corresponding access control list comprised of access control entries, whereby each access control entry identifies a trustee and specifies the access rights allowed, denied, or audited for that trustee. Thus, determinations regarding the user's access rights for one or more resources for which they are attempting to access may be made, including whether the user is denied access to those resources, whether the user is authorized to access those resources, and the role types that the user has for resources that are accessible by the user (e.g., read, write, execute). This information may then be sent to one or more Sets that represent the corresponding resource or resources for which these determinations have been made, and access to one or more nodes corresponding to those resources may be granted or denied in line with the determined access rights for the user based on the access control list determinations made at the resource container level in the application database.

According to other examples, external authorization to access one or more resources associated with a Set may comprise one or more of the following elements. A request to access one or more resources of a Set may be received by an application database corresponding to that Set. Upon receiving that request, the application database and/or a caller application associated with that application database may request permission information for accessing the one or more resources related to the access request from the Set. The requested permission information may comprise one or more access types for one or more resources of the Set as they relate to the access request. For example, access type permissions that may be associated with the requested resources from the Set may include a read role for one or more resources, a write role for one or more resources, and an execute role for one or more resources. Upon receiving the permission information from the Set, the identity provider may generate an access token for the user that comprises one or more of a user identifier, an identifier for one or more of the requested resources associated with the Set, and one or more access types that the user has for the Set. The generated access token may be sent to the Set, and access may be granted to the one or more resources that the request was for based on the information provided in the access token.

According to examples, a request to access one or more resources, and/or one or more nodes associated with a Set (e.g., a shared graph) corresponding to an application database (e.g., one or more resource containers) that hosts the one or more resources, may comprise a user's unique identifier (e.g., a client ID) and an object ID (e.g., a resource container ID or resource ID). For example, a shared graph corresponding to graph identifier 0x101, may have permissions that are defined as follows:

```
{
  “resourceContainer”: “a link to the actual resource or resource
  container”,
  “authUri”: “a link that handles authZ”
}
```

For example, given an incoming user ID 0x123, and a shared graph with permission:

{

“resourceContainer”: “https://any/meetings/1/attendees”,
“authUri”: “https://any/authorize”

}

For internal authentication of the above request, the shared/generic graph 0x101 may invoke the following “authUri”:

POST https://any/authorize
{

“uniqueId”: 0x123,
“resourceContainer”: “https://any/meetings/1/attendees”

}

The resulting response may be provided:

{

“roles”: [“read”, “write”]

}
-or-
{

“roles”: [ ]

}

For external authorization authentication, by which an application database and/or a caller application (e.g.,a client app to access a Set) may obtain permission information from the Set and subsequently call into the “authUri” and if an ID associated with the user that made a resource request has authentication information that provides access to one or more resources in the Set, the application database and/or the caller application may add a “roles” claim to a user token that may be provided to the Set for retrieval of a requested resource. Thus, the application database and/or the caller application may provide the Set with the following:

{

“uniqueId”: 0x123,
“roles”: [“read”, “write”],
“target”: 0x101

}

As such, an immediate determination may be made as to whether a user's request for resource access should be granted or denied based on the “roles” and “target” claims provided in the user access token. According to examples, the application database and/or caller application may be pre-authorized to fetch permission information for a generic shared graph with a natural boundary (e.g., a tenancy boundary). In some examples, the permission information may be encrypted by a Set when it is provided to a caller application. According to other examples, the permission information may be encrypted by a caller application with a public key associated with a caller application's public key.

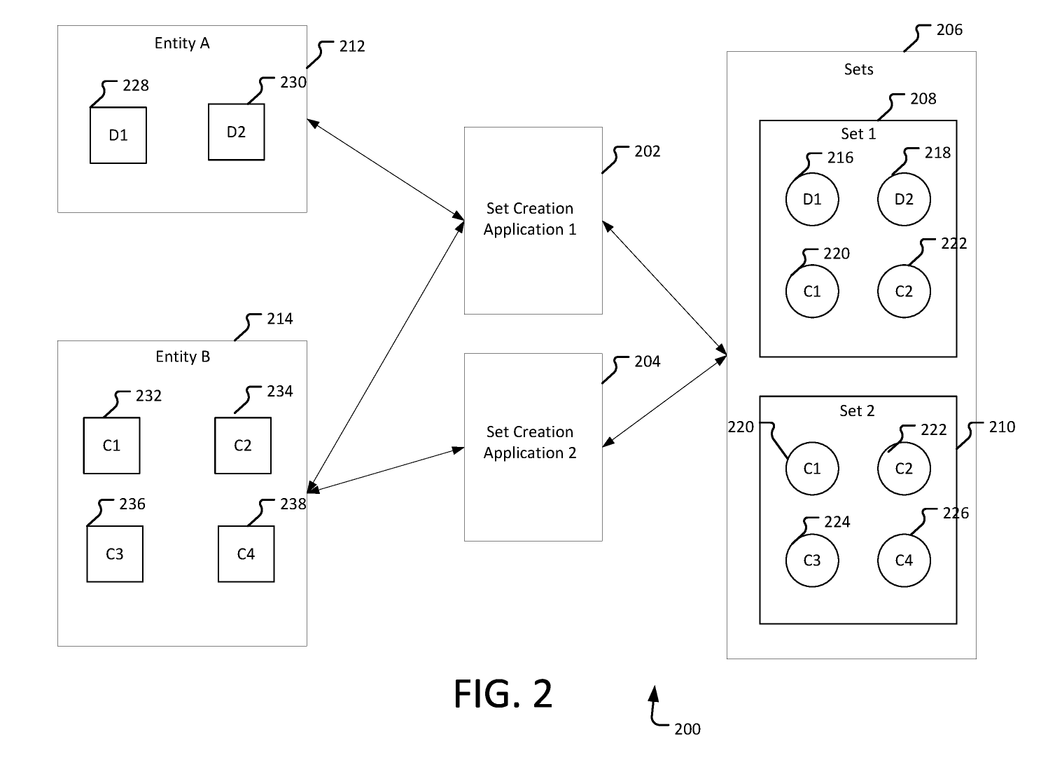

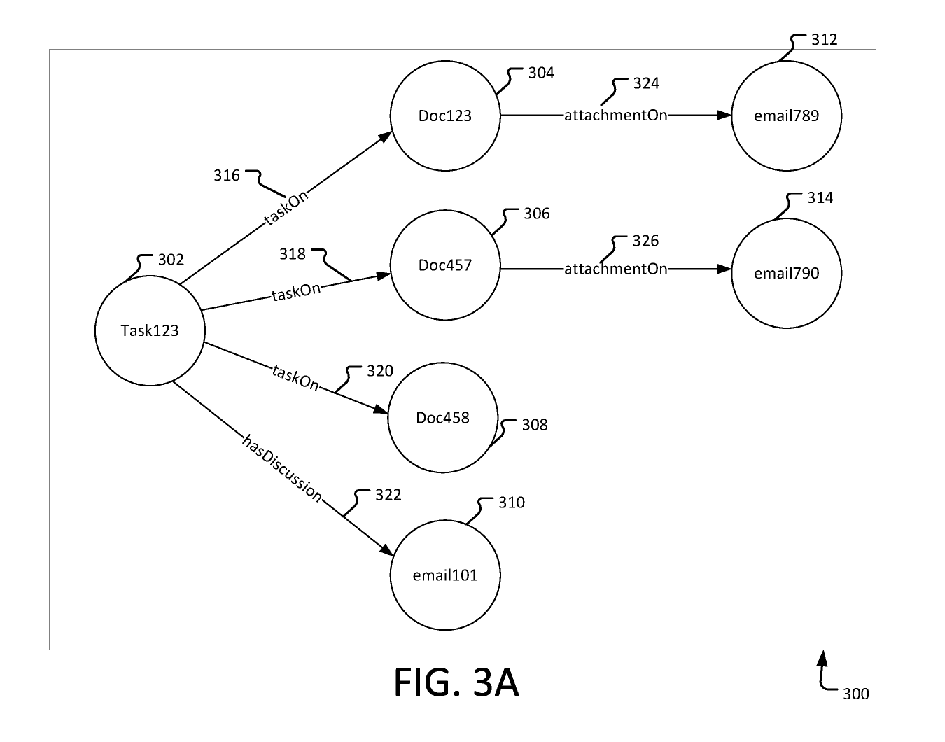

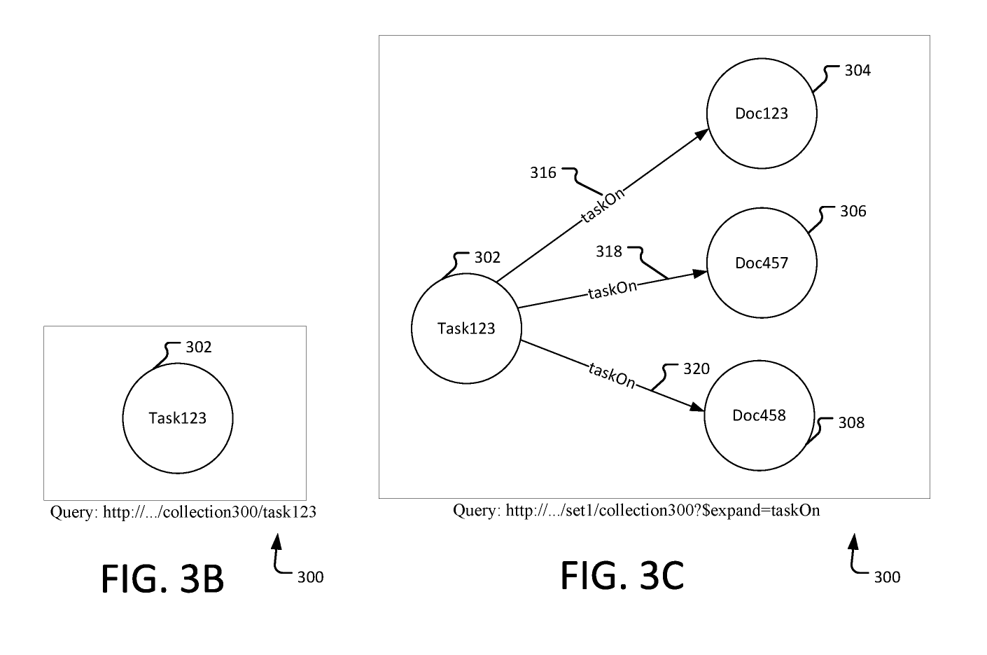

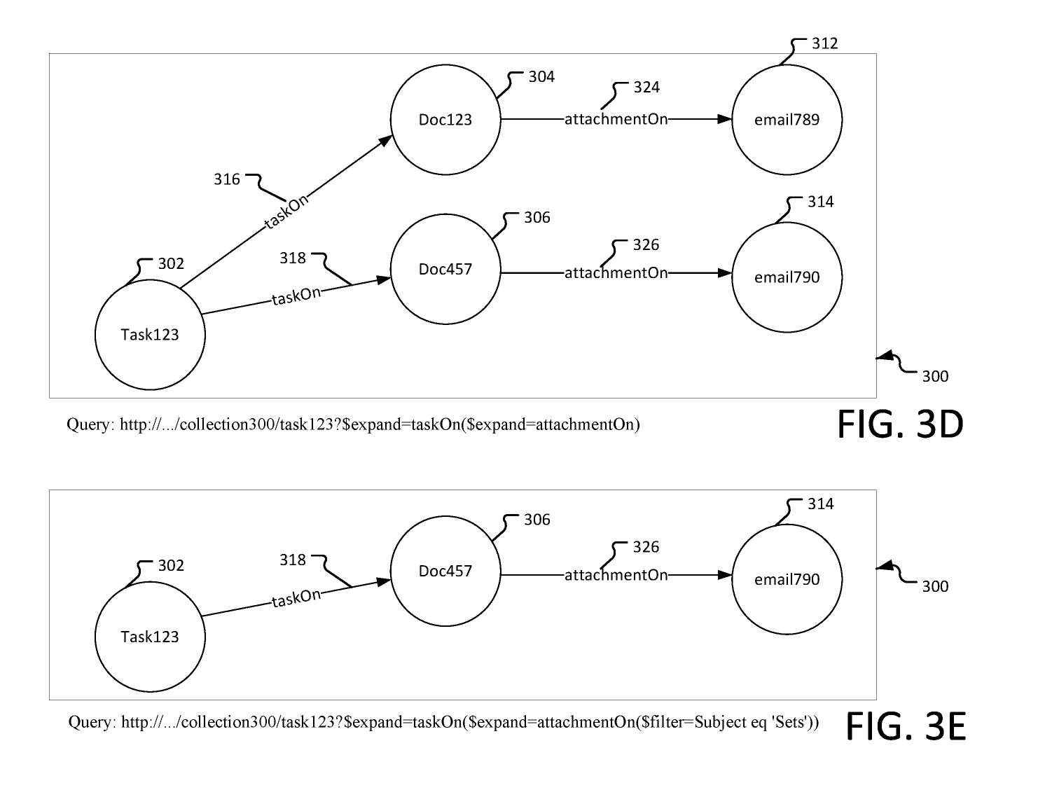

Various different data structures may be employed to represent the relationships amongst nodes, node attributes, and resources and resource properties. For example, a linked list or a relational database may be used to store information about nodes and resources. Alternatively, a graph, also referred to herein as a Set, may be used to represent various nodes and resources and their corresponding attributes and properties. Additional information regarding the creation and use of a Set will be provided below with respect to FIGS. 2 and 3.

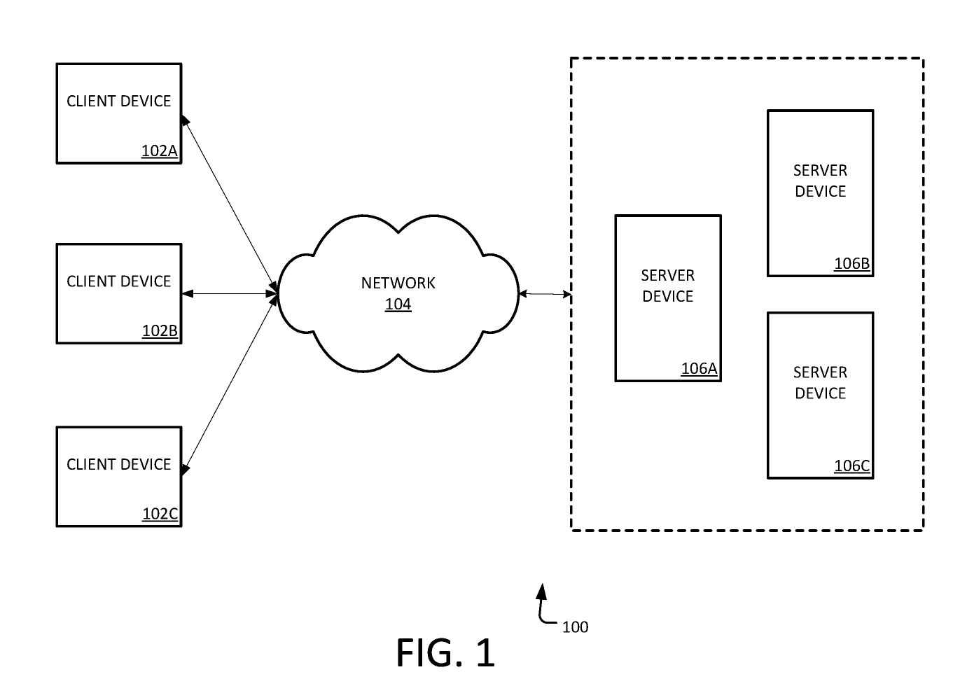

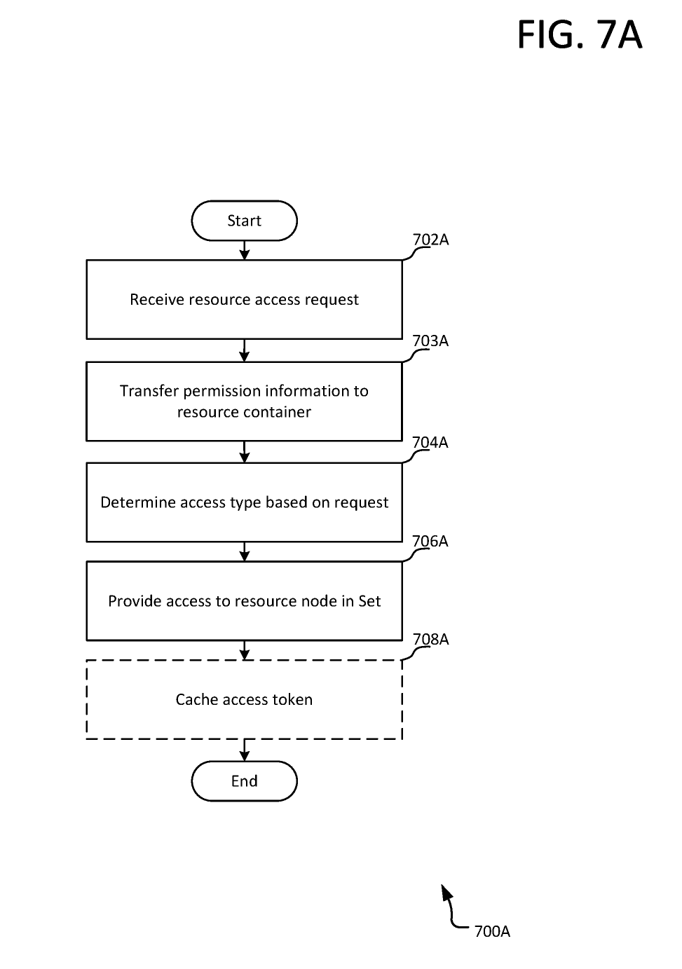

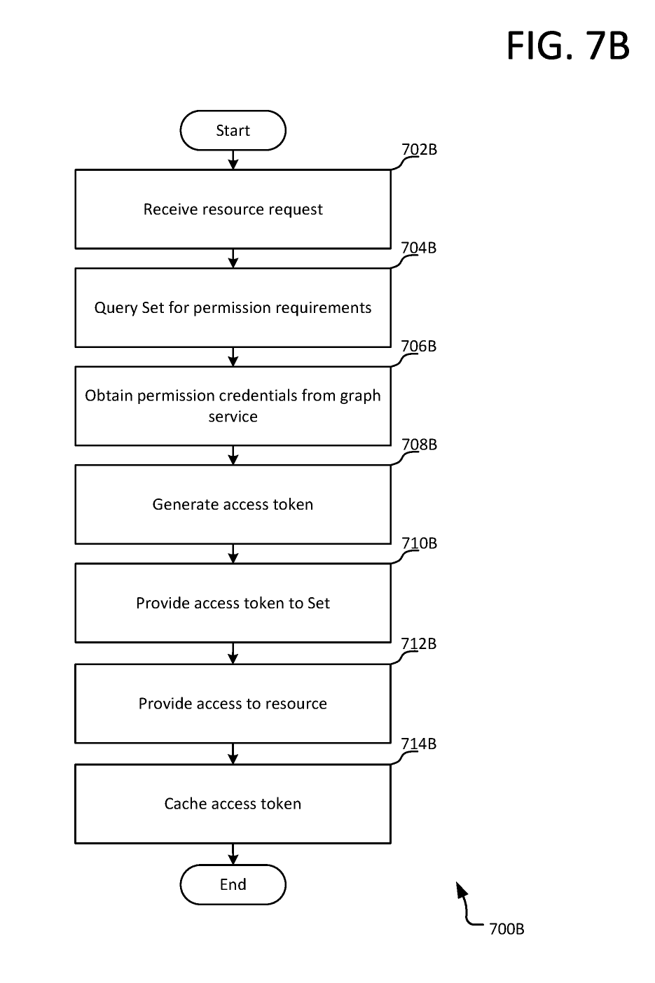

FIG. 1 illustrates an overview of an example system 100 for providing access to one or more nodes associated with a shared graphical dataset. Example system 100 may be a combination of interdependent components that interact to form an integrated whole for performing delegated authentication. In aspects, system 100 may include hardware components (e.g., used to execute/run operating system (OS)), and/or software components (e.g., applications, application programming interfaces (APIs), modules, virtual machines, runtime libraries, etc.) running on hardware. In particular aspects, system 100 may provide an environment for software components to execute, evaluate operational constraint sets, and utilize resources or facilities of the system 100. In such aspects, the environment may include, or be installed on, one or more processing devices. For instance, software (e.g., applications, operational instructions, modules, etc.) may be run on a processing device such as a computer, mobile device (e.g., smartphone/phone, tablet, laptop, personal digital assistant (PDA), etc.) and/or any other electronic device. As an example of a processing device operating environment, refer to the exemplary operating environments depicted in FIGS. 7-11. In other instances, the components of systems disclosed herein may be distributed across and executable by multiple devices. For example, input may be entered on a client device and information may be processed or accessed from other devices in a network (e.g. server devices, network appliances, other client devices, etc.).

As presented, system 100 comprises client devices 102A-C, distributed network 104, and a distributed server environment comprising one or more servers, such as server devices 106A-C. One of skill in the art will appreciate that the scale of systems such as system 100 may vary and may include additional or fewer components than those described in FIG. 1. In some aspects, interfacing between components of the system 100 may occur remotely, for example, where components of system 100 may be distributed across one or more devices of a distributed network.

In aspects, client devices 102A-C may be configured to receive input via a user interface component or other input means. Examples of input may include voice, visual, touch and text input. The interface component may enable the creation, modification and navigation of various data sets and graphical representations. In examples, the various datasets may comprise (or be otherwise associated with), for example, resource identifiers, resource metadata, relationship information, asserted relationships, graphical mapping information, query data, rule sets, such as, for example, inference rules, authorization information, authentication information, etc., as discussed in further detail below. Generally, the datasets are stored on one or more server devices 106A-C and are accessible by the client devices 102A-C. In some examples, however, the datasets may be at least partially stored on one or more of the client devices 102A-C. The underlying resources represented in the various datasets may be stored locally or in a data store, such as a cloud storage application, accessible to client devices 102A-C. In at least one example, the underlying resources represented in the various datasets (or portions thereof) may be distributed across client devices 102A-C. For instance, client device 102A (e.g., a mobile phone) may locally store a first portion of the resources represented in the dataset, client device 102B (e.g., a tablet) may locally store a second portion of the resources, and client device 102C (e.g., a laptop) may locally store the remaining portion of the resources represented in the dataset. In examples, the client devices 102A-C may have access to all of the resources included in the data set, may have access to a subset of the resources included in the dataset, or, alternatively, may not have access to any of the resources included in the dataset.

Client devices 102A-C may be further configured to interrogate data stores comprising the resources corresponding to the resource identifiers in the various data sets. In examples, client devices 102A-C may interrogate content providers, such as server device 106A-C, via distributed network 104. The interrogation may include identifying the remote device on which a resource is located, and/or determining whether the remote device (or a service/separate remote device) has authenticated access to the resource. If access to the resource has been authenticated, client devices 102A-C may retrieve an authentication indication from the remote device. Client devices 102A-C may use the authentication indication to provide access to one or more of the various datasets comprising the corresponding resource identifier.

Server devices 106A-C may be configured to store and/or provide access to one or more resources. For example, server device 106A may be a web server, server device 106B may be a device comprising a collaborative messaging tool and a calendaring application, and server device 106C may be electronic mail server. Each of these devices may comprise a repository of resources that is accessible via one or more authentication mechanisms. In examples, server devices 106A-C may perform or monitor the authentication process when a request for a resource is received. If the authentication is successful, the authenticating device may store or maintain an authentication indication for a specified period of time. When the period of time expires, server devices 106A-C may remove or attempt to renew the authentication indication. In examples, server devices 106A-C may provide the authentication indication to an interrogating client device. In some aspects, server devices 106A-C may further be configured to store at least a portion of the various data sets and graphical representations, as discussed above.

FIG. 2 illustrates an overview of an example system 200 for managing isolated collections of resource identifiers and corresponding relationships. The isolated collection techniques implemented in system 200 may comprise or be associated with one or more of the delegated authentication techniques described in FIG. 1. In alternative examples, a single device (comprising one or more components such as processor and/or memory) may perform the processing described in systems 100 and 200, respectively.

With respect to FIG. 2, system 200 may comprise Set creation applications 202 and 204, Set environment 206, Sets 208 and 210, entities 212 and 214, resources identifiers 216, 218, 220, 222, 224 and 226, and resources 228, 230, 232, 234, 236 and 238. In aspects, Set creation applications 202 and 204 may be an application or service configured to create, infer, manipulate, navigate and visualize various resources, relationships and graphical representations. Set creation applications 202 and 204 may define collections of relationships between resources (e.g., people, files, tasks, mail, documents, calendar events, etc.) and executing queries on those collections. Set creation applications 202 and 204 may further provide for defining and storing rule sets used to infer one or more relationships in the collections, and displaying graphical representations of the collection data. The defined rulesets may be stored in the Set itself, and in some examples is stored as metadata within the Set. In examples, Set creation applications 202 and 204 may be installed and executed on a client device or on one or more devices in a distributed environment. For instance, Set creation application 202 may be installed on client device 102A, Set creation application 204 may be installed on client device 102B, and a Set creation service associated with server device 106A may be accessible to client device 102C.

In aspects, Set creation applications 202 and 204 may have access to a file directory or an execution environment, such as environment 206. Environment 206 may be co-located with a Set creation application, or environment 206 may be located remotely from the Set creation application. Environment 206 may provide access to one or more data collections, such as Sets 208 and 210. In examples, access to the data collections may be determined using one or more sets of permissions generated and/or maintained by Set creation applications 202 and 204. The sets of permissions may be different across one or more of the data collections. As a result, one or more of the data collections (or functionality associated therewith) may not be accessible from one or more of Set creation applications 202 and 204.

Sets 208 and 210 may respectively comprise isolated collections of asserted resource identifiers and corresponding relationships. The relationships in the isolated collections may be defined manually or may be automatically derived using one or more rule sets. The isolated collections may be represented using graphical structures that directly relate resources in the data collection and provide for retrieving relationship data with a single operation. Each isolated collection may comprise resource identifiers that are unique to that isolated collection. Alternately, the isolated collections may comprise resource identifiers included in one or more alternate isolated collections. For example, as depicted in FIG. 2, Set 208 may comprise resource identifiers 216, 218, 220 and 222, and Set 210 may comprise resource identifiers 220, 222, 224 and 226. Resource identifiers 216, 218, 220, 222, 224 and 226 may correspond to, and/or identify the location of, one or more resources. As used herein, a resource identifier references an existing resource, but is not itself a resource. Exemplary types of resource identifiers include, but are not limited to, a Uniform Resource Identifier (e.g., a Uniform Resource Locator (URL), a Uniform Resource Name (URN) etc.), an IP address, a memory or storage address, and the like. One of skill in the art will appreciate that any type of identifier may be employed by the various aspects disclosed herein without departing from the scope of this disclosure. Identifying the location of a resource may include parsing the resource identifier using, for example, regular expressions, providing one or more portions of the resource identifier to a search utility, executing the resource identifier, etc. In aspects, having access to the data collections does not guarantee access to the resources identified by the resource identifiers included in each data collection. For example, although a user may be able to access and manipulate Set 208, the user may not be authorized to access one or more of the underlying resources corresponding to the resource identifier in Set 208.

Resource providers 212 and 214 may be configured to store and/or provide access to one or more resources. As such, a resource provider as used herein may be a data store, a cloud service provider, a client computing device, a server computing device, a distributed system of devices, such as, for example, an enterprise network, an application, a software platform (e.g., an operating system, a database, etc.), and the like. In aspects, resource providers 212 and 214 may be (or have access to) various different data sources, such as content providers, data stores, various sets of application data, and the like. The data stores may comprise one or more resources corresponding to one or more resource identifiers. For example, as depicted in FIG. 2, resource provider 212 may be a data store comprising various different types of resources such as resource 228 (e.g., document 1 (D1)) and resource 230 (e.g., presentation 2 (D2)) and resource provider 214 may be a contact management application comprising contact resources 232 (e.g., contact 1 (C1)), 234 (e.g., contact 2 (C2)), 236 (e.g., contact 3 (C3)) and 238 (e.g., contact 4 (C4)). In this example, resource identifier 216 may correspond to resource 228; resource identifier 218 may correspond to resource 230; resource identifier 220 may correspond to resource 232; resource identifier 222 may correspond to resource 234; resource identifier 224 may correspond to resource 236; and resource identifier 226 may correspond to resource 238. In some aspects, resource providers 212 and 214 may be accessible by Set creation applications 202 and 204. Set creation applications 202 and 204 may access resource providers 212 and 214 to determine the existence of resources and/or retrieve information associated with the resources (e.g., resource metadata, resource location, resource identifiers, permission sets, authentication data, etc.). The information retrieved from resource providers 212 and 214 may be used to determine a set of resource identifiers corresponding to one or more of the available resources. The set of resource identifiers may be used to create one or more isolated collections of asserted resource identifiers and corresponding relationships. As noted above, the resource identifiers may be, or include, a durable URI for its corresponding resource. For instance, the resource identifier 216 may include the URI for the actual document (D1) 228. Accordingly, in such an example, a user is able to determine the location of the document (D1) 228 from the Set, and, depending on authentication and access restrictions, retrieve the document (D1) 228. As another example, as depicted in FIG. 2, resource provider 212 may be accessed by Set creation application 202. Set creation application 202 may determine that resource provider 212 comprises at least resources 228 and 230, and may determine resource identification information for each of the resources. Based on the determined resource identification information, resource identifiers 216 and 218 may be respectively applied/correlated to resources 228 and 230, and provided to environment 206. Environment 206 may then make resource identifiers 216 and 218 eligible for an inclusion analysis into one or more isolated collections.

FIG. 3A illustrates an example isolated collection 300 of asserted resource identifiers and corresponding relationships. Example isolated collection 300 comprises resource identifiers 302, 304, 306, 308, 310, 312 and 314, and relationships 316, 318, 320, 322, 324 and 326. In aspects, isolated collection 300 may be generated and/or manipulated using a collection creation utility that may be included as part of a Set creation application as discussed above. When presented in graph form as depicted in the FIG. 3A, each resource identifier may be referred to as a “node” and each relationship may be referred to as an “edge.” The collection creation utility may also identify resources and/or determine resource types for collections using one or more rule sets that may include rules defined in accordance with semantic web technologies, such as resource description framework (RDF), RDF schema (RDFS), SPARQL Protocol and RDF Query Language (SPARQL), Web Ontology Language (OWL), etc. For example, collection 300 includes a resource identifier 312 that represents an underlying resource, “email789” in the depicted example. Similarly, resource identifier 304 represents a resource document, “Doc123,” and resource identifier 302 represents a resource task, “Task123.” Each of the resources and relationships included in the isolated collection 300 may have been asserted by a developer through a Sets creation application. For instance, a developer may manually add each of the resource identifiers and the relationships between the resource identifiers. As an example, the developer may manually indicate that the “task123” is a task on “Doc123,” as represented in the collection 300 by the “taskOn” relationship 316. The resource identifiers and relationships may also be asserted by an external bot or application created by a developer. For instance, an add-in may be programmed to monitor activity in a browser or other application to track usage of the application. Based on the usage of the application, the add-in sends additional resources and relationships to be included in the collection 300.

In contrast to the asserted resource identifiers and relationship, a collection creation utility may execute a ruleset to determine additional relationships and resource types, referred to herein as “inferred relationships” and “inferred resource identifiers” or “inferred resource types.” For example, upon execution of a ruleset, the collection creation utility may determine that resource identifier 312 represents an email message, and resource identifier 304 represents a document. Generation of inferred relationships and resources is discussed in further detail below.

Isolated collection 300 further depicts that resource identifier 302 is associated with resources identifiers 304, 306 and 308 and resource identifier 310. The collection creation utility may determine that the resource identifier 302 represents a task to be performed on identifiers 304, 306, and 308. Based on this determination, the collection creation utility may assign relationships 316, 318 and 320 (e.g., “taskOn”) to define the association between resource identifier 302 and resource identifier 304, 306 and 308. In other examples, the relationships 316, 318, and 320 may be asserted, as discussed above. Additional relationships, such as the “hasDiscussion” relationship 322 may have been asserted manually by a developer or asserted from an add-in of an e-mail application that analyzed the content of e-mail 101. While specific types of resources and relationships are described in FIG. 3A, one of skill in the art will appreciate that other types of resources and/or relationships may be included in an isolated collection without departing from the spirit of this disclosure.

FIGS. 3B-3E illustrate an example query model that may be used to traverse collection 300. In aspects, queries may be executed via an interface provided by the collection creation utility. A query may be executed against one or more files and/or directories comprising information, such as resource identifiers, resource type, resource metadata, permission data, etc. The query results may be visualized in a graph form as one or more collections, such as collection 300. For example, the entire collection 300 dataset may comprise only those elements illustrated in collection 300 (e.g., resource identifiers 302, 304, 306, 308, 310, 312 and 314 and relationships 316, 318, 320, 322, 324 and 326). In this particular example, resource identifier 312 may represent an email comprising the subject “API Design” and resource identifier 314 may represent an email comprising the subject “Sets.” The query ‘http:// . . . /collection300/task123’ may be executed against collection 300. The query results may comprise resource identifier 302 and be visualized as illustrated in FIG. 3B. In FIG. 3C, the query has been amended to ‘http:// . . . /collection300/task123?$expand=taskOn’ and executed against collection 300. The query results may comprise resource identifiers 302, 304, 306 and 308 and relationships 316, 318 and 320, and be visualized as illustrated in FIG. 3C. In FIG. 3D, the query has been amended to ‘http:// . . . /collection300/task123?$expand=taskOn($expand=attachmentOn)’ and executed against collection 300. The query results may comprise resource identifiers 302, 304, 306, 308, 312 and 314 and relationships 316, 318, 320, 324 and 326, and be visualized as illustrated in FIG. 3D. In FIG. 3E, the query has been amended to http:// . . . /collection300/task123?$expand=taskOn($expand=attachmentOn($filter=Subject eq ‘Sets’))' and executed against collection 300. As only resource identifier comprises 314 the subject “Sets”, the query results may comprise resource identifiers 302, 306 and 314 and relationships 318 and 326, and be visualized as illustrated in FIG. 3E.

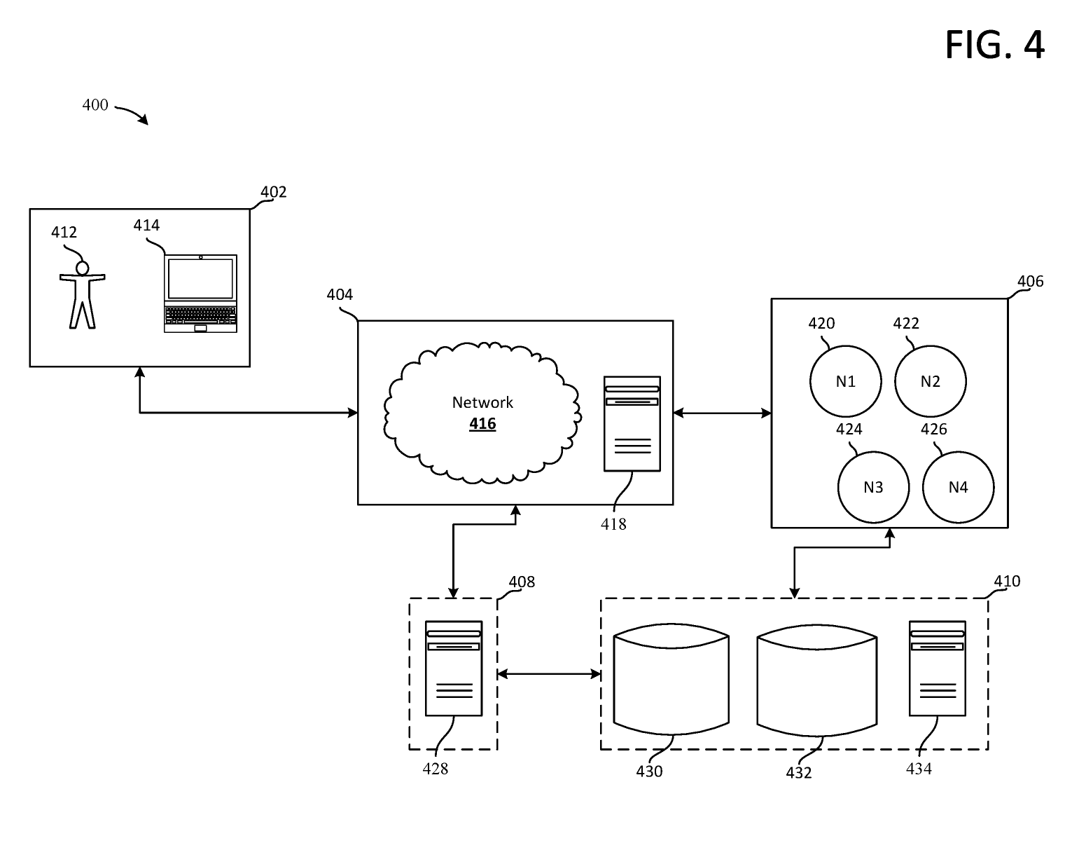

FIG. 4 illustrates an exemplary distributed computing environment 400 for authenticating one or more access types for one or more nodes associated with a shared graphical dataset. Environment 400 includes user interaction sub-environment 402, including user 412 and one or more computing devices, such as user computing device 414. Environment 400 also includes network and authentication processing sub-environment 404, including network 416 and server computing device 418. Also included in environment 400 is caller application sub-environment 408, including server computing device 428, application database and processing sub-environment 410, including first application dataset 430, second application dataset 432, and server computing device 434. Exemplary distributed computing environment 400 also includes Set 406, which is a graphically represented node structure that provides access to resources, and the relationships amongst resources, which may be indexed and stored in one or more application datasets, such as first application dataset 430 and second application dataset 432.

User 412 in user interaction sub-environment 402 may access one or more application databases, such as a document creation and editing database, a calendaring application database, a real-time communication database, etc., which store and provide access to resources such as documents, contact data, calendar data, image data, etc., which may be stored on one or more storage devices associated with application databases, such as first application dataset 430 and second application dataset 432, although there may be more or fewer datasets corresponding to those databases while conforming to aspects of the disclosure provided herein.

According to examples, first application dataset 430 may comprise saved word processing resources and related content associated with a service that user 412 may have access to and second application dataset 432 may comprise saved email and calendar resources and related content associated with a service that user 412 may have access to. Both of first application dataset 430 and second application dataset 432 may have authentication elements for the resources that they host, which may apply to user 412 as a member of a particular group, such as a tenant group, as well as additional users that may belong to one or more tenant groups. For example, user 412 may have access and authentication credentials that grant user 412 a certain type of access (e.g., a read access role, a write access role, an execute access role) to one or more resources hosted on first application dataset 430 and second application dataset 432, while other users within tenant groups associated with those application datasets may have other types of access to one or more resources hosted on first application dataset 430 and second application dataset 432.

According to some examples, user 412 may attempt to access a resource, or attribute of a resource related to one or more nodes in Set 406, for which the resource is hosted on one or more application datasets, such as first application dataset 430 and second application dataset 432. For example, user 412 may provide a query, via network 416, to one or more application datasets or Sets related to resources of an application dataset that user 412 has access to.

According to an example, whereby an internal authorization process is executed, user 412 may provide a request to access one or more resources of a Set, such as Set 406, via user computing device 414, a caller application, and network 416, to one or more computing devices that hosts a Set, such as Set 406. The request may comprise an access request token comprising one or more of the following: a unique identifier for user 412, one or more unique resource identifiers corresponding to the one or more resources that user 412 is attempting to access, an authorization identifier (e.g., a URI provided by one or more resource containers hosted by an application database such as first or second application databases 430 and 432 in application database and processing sub-environment 410), and a clearance level associated with user 412 for one or more resources hosted on one or more application databases, such as first application database 430 and second application database 432.

Upon receiving the request, Set 406 may call into an authorization endpoint, such as one or more resource containers hosted by an application database, (e.g., first or second application databases 430 and 432 in application database and processing sub-environment 410). The one or more resource containers called into may correspond to one or more resources represented at the node level by the Set 406.

The resource request (i.e., the access request token) may be received by one or more resource containers hosted by one or more of first application database 430 and second application database 432, and determinations may be made by one or more computing devices, such as server computing device 434, regarding user 412's authorized access types as they relate to the one or more resources that are hosted therein. For example, one or more of the resources that user 412 is attempting to access may be hosted on one or more of first application database 430 and second application database 432, and an associated resource container (e.g., a file, a folder, etc.) may be associated with each of those resources. Each of those containers may further provide an access control list comprised of access control entries, whereby each access control entry identifies a trustee and specifies the access rights allowed, denied, or audited for that trustee. Thus, user 412's request to access one or more resources may be routed through a corresponding resource container and an associated access control list in determining whether user 412 has credentials to access, and to what degree user 412 has access to, requested resources, including whether to provide access to a requested resource, whether to deny access to a requested resource, and whether user 412 has one or more role types associated with a requested resource (e.g., read, write, execute).

Upon receiving and evaluating the access token for user 412 for accessing one or more of the resources hosted by first application database 430 and second application database 432, that information may be sent to one more Sets, such as Set 406, and access to the resources associated with Set 406, as well as the relationship information associated with Set 406 (e.g., relationships amongst nodes 420, 422, 424, and 426) may be granted or denied in accordance with the determined access rights for user 412 based on the access control list determinations that have been made at the resource container level with regard to first application database 430 and second application database 432.

According to an example, whereby an external authorization process is executed, user 412 may provide a request to access one or more resources of a Set, such as Set 406, via user computing device 414 and network 416, to an application database or a server computing device associated with an application database, such as first or second application databases 430 and 432 and/or server computing device 434. According to some examples, the user request may be processed by one or more computing devices, such as server computing device 428, which host a caller application associated with one or more application databases. Thus, a request may be generated from one of server computing device 434 and/or server computing device 428 for permission information for accessing one or more resources related to the access request from user 412, for which the associated resources that are being requested are embodied in one or more nodes in a Set such as Set 406 and associated nodes 420, 422, 424, and 426. The requested permission information may comprise one or more access types for one or more resources of Set 406 as they relate to access requests. For example, access type permission that may be associated with the requested resources from Set 406 may include a read role for one or more resources, a write role for one or more resources, and an execute role for one or more resources.

The requested permission information may be provided back to one or more of application database 430, second application database 432, and server computing device 428 which services a caller application for the one or more requested resources. Upon receiving the permission information from Set 406, the application database and/or the caller application may generate an access token for user 412 that comprises one or more of a user identifier, an identifier for one or more of user 412's requested resources associated with a Set, such as Set 406, and one or more access types that user 412 has for the requested Set. The generated access token may be sent to Set 406, and access may be granted to the one or more resources that the request from user 412 was for based on the information provided in the access token.

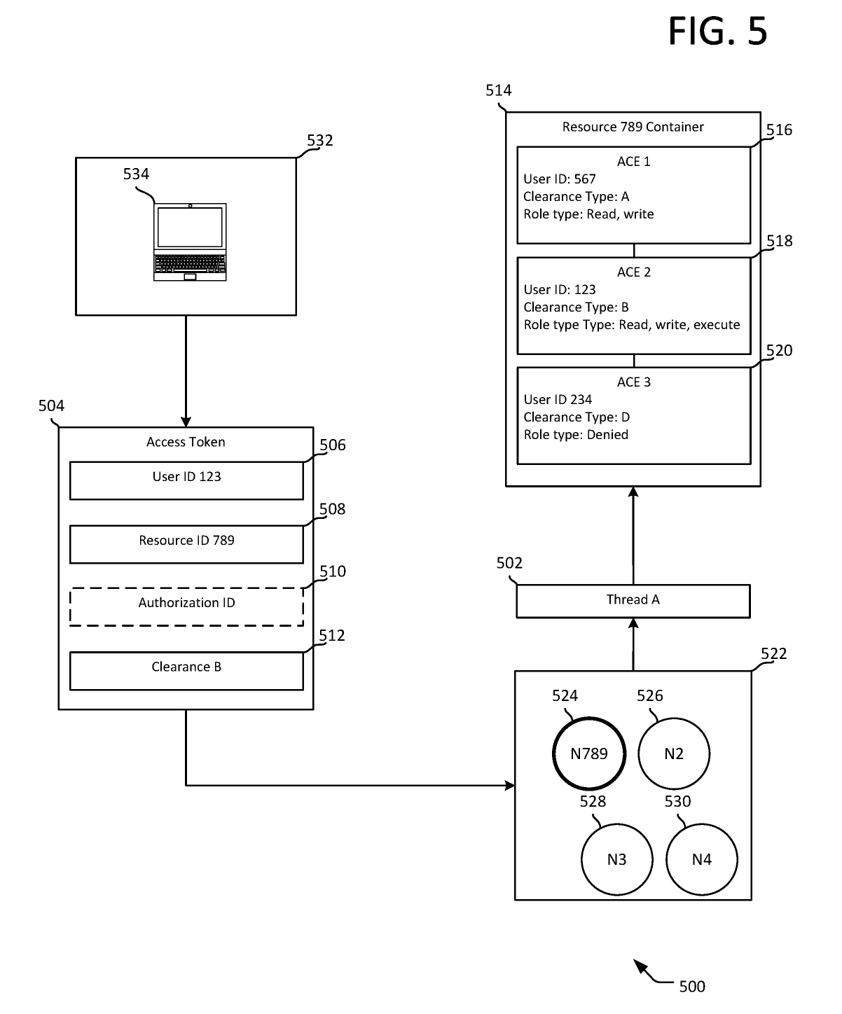

FIG. 5 is an exemplary diagram 500 for performing internal authorization of a request to access one or more resources associated with a shared graphical dataset and one or more nodes, such as nodes 524, 526, 528, and 530, in Set 522, representing the one or more resources. For example, a request to access one or more resources associated with a Set, such as Set 522 may be sent from a caller application, such as a caller application accessed from computing device 534 in user computing sub-environment 532, and received by the Set. According to examples, the request may comprise an access token, such as access token 504. The access token may comprise one or more of a unique user identifier, such as user ID 506 for the user making the request, one or more unique resource identifiers corresponding to the one or more resources that the user is attempting to request, such as resource identifier 508, an authorization identifier, such as authorization ID 510, and a clearance level identifier associated with the user making the request, such as clearance level ID 513.

According to examples, Set 522 may receive the resource request (e.g., access token 504), which may provide information associated with the resource request (e.g., one or more of user ID 506, Resource ID 508, authorization ID 510, and clearance type B element 512), and provide that information, via an access thread (e.g., thread A 502) associated with Set 522, to one or more resource containers, such as resource container 514 associated with Set 522. The resource container 514 may be associated with an access control list comprising one or more access control entries which include criteria that the provided access token may be matched against to determine whether access may be provided to requested resources associated with the access token 504, and to what degree or access type/role those access types correspond to (e.g., read, write, execute). According to examples, access token 504 may be provided to resource container 514, and that token may be matched against an access control list provided in resource container 514, which comprises a plurality of access control entries (i.e., elements in an access control list that control or monitor access to an object by a specified trustee), such as access control entries 516, 518 and 520. The access token 504 may be processed and matched against the access control entries 516, 518 and 520 to make determinations regarding the access available to a user in relation to a request (e.g., a query) for a requested resource hosted by one or more application databases.

For example, a determination may be made that access token 504 provides read, write, and execute access rights to one or more resources associated with resource container 514 because the user ID 123 506 corresponds to the user ID of access control entry 518, and associated read, write, and, execute access types for that resource container 518 correspond to that user ID 506. Additionally, the clearance type B element 512 in the access token 504, may correspond to an access type for an entire Set, such as Set 522, which may be applied in processing resource queries and/or resource access requests that relate to resources represented in Set 522 and/or related nodes and resources represented by nodes in related Sets or related subsets of Set 522.

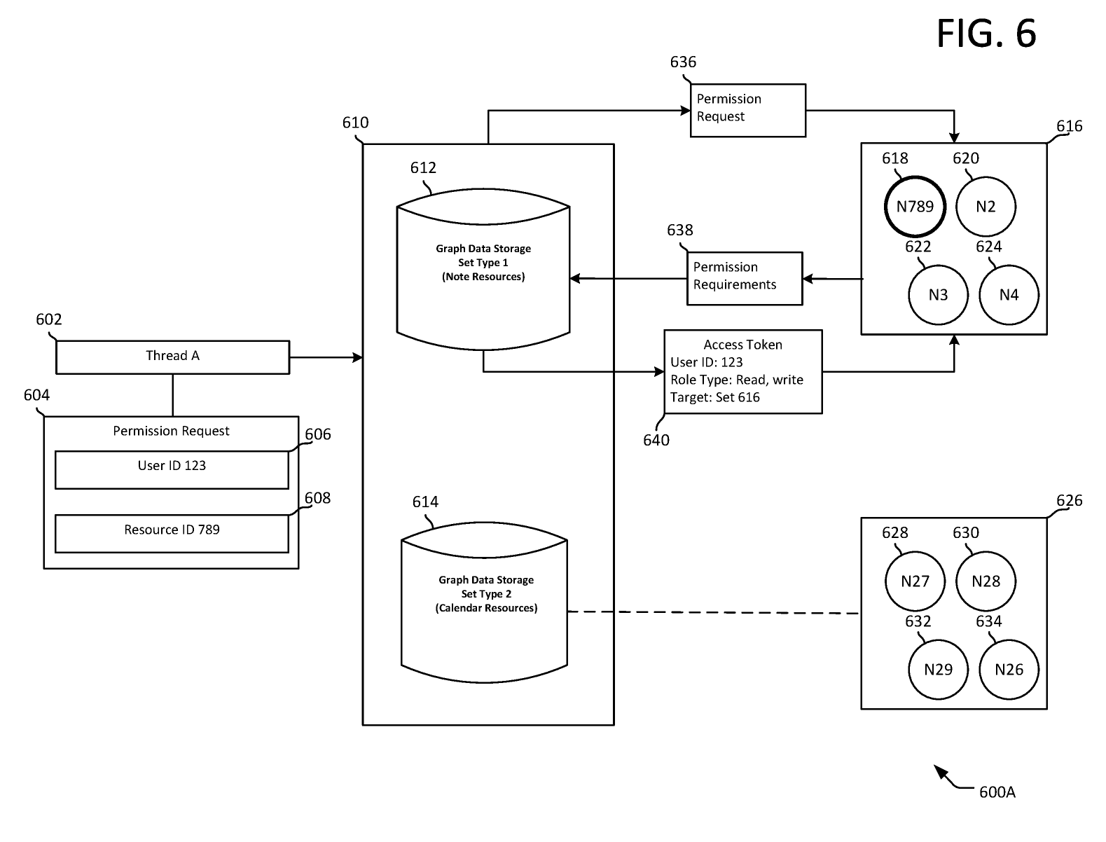

FIG. 6 is an exemplary diagram of an environment 600 for performing external authorization of a request to access one or more resources associated with a shared graphical dataset and one or more nodes of a Set representing the one or more resources. Environment 600 includes thread A 602, by which a permission request, such as permission request 604, may be generated and sent by a user computing device to an application database and/or a caller application to one or more Sets for a determination as to what authentication requirements may be required to authenticate access to one or more resources associated with those Sets. For example, a permission request including a user identifier, such as user identifier 606, and a resource identifier, such as resource identifier 608, may be provided to one or more application databases and/or a caller application, such as caller environment 610, which comprises graph data storage set type 1 612, and graph data storage set type 2 614.

A request for permission information related to one or more requested resources may be generated and sent by caller environment 610 to one or more Sets, such as Set 616 and Set 626. Set 616 comprises one or more nodes (e.g., nodes 618, 620, 622, and 624) associated with note resources hosted by graph data storage set type 1 612. Alternatively, Set 626 comprises one or more nodes (e.g., nodes 628, 630, 632, and 634) associated with resources for calendar resources hosted by graph data storage set type 2 614. Each of Sets 616 and 626 and/or nodes within those Sets (e.g., nodes 618, 620, 622 and 624 corresponding to Set 616; and nodes 628, 630, 632, and 634 corresponding to Set 626) may have a unique URI corresponding to an application dataset that hosts resources that are associated with those Sets. For example, Set 616 may have a unique URI that may indicate that note resources hosted by graph data storage set type 1 612 are represented in Set 616 (along with corresponding authentication requirements for accessing the resources associated with Set 616), and Set 626 may have a unique URI that may indicate that calendar resources hosted by graph data storage set type 2 614 are represented in Set 626 (along with corresponding authentication requirements for accessing the resources associated with Set 626).

According to examples, the resource identifier 608 may provide a URI that is directed to particular Set for which the permission request should be sent in order to fulfill a resource access request. For example, resource identifier 608 has an ID of 789, which corresponds to node 618, which is associated with a resource (resource 789) that corresponds to permission request 604. Thus, a permission request, such as permission request 636, may be provided to Set 616, and a determination may be made as to what authorization requirements node 618, and/or Set 616 as a whole, require in authorizing access to a resource represented in Set 616 and/or to access certain role types associated with a resource represented in Set 616 (e.g., the resource associated with node 618 and resource identifier 789).

Upon making a determination as to the requirements for accessing a resource represented in Set 616 and/or to access certain role types associated with a resource represented in Set 616, permission requirements 638 may be provided to an application database that contains authorization information for one or more users (or user accounts associated with that application database), such as a user or user computing device that generated permission request 604. Specifically, Set 616, containing node 618, which corresponds to and is associated with the resource identifier 608 for which permission request 604 was generated, may contain a unique URI for an application dataset that has authorization permissions for users and/or tenants that may access one or more nodes in Set 616. For example, Set 616 may represent resources that correspond to note resources that are hosted by an application dataset such as graph data storage set type 1 612, and permission request 638 may therefore be provided to graph data storage set type 1.

Upon receiving permission requirements 638 from Set 616, graph data storage set type 1 may determine whether user identifier 606 is associated with authorization information corresponding to one or more resources hosted by graph data set type 1 and/or whether that authentication information may meet the authentication requirements 638 that are necessary to access one or more resources associated with Set 616, such as the resources that are associated with node 618 and the resource identifier 608 provided in permission request 604. If credentials corresponding to user identifier 606 which meet permission requirements 638 for accessing Set 616 are determined to be associated with graph data storage set type 1, a user access token, such as access token 640 may be generated by graph data storage set type 1 and/or a related caller application, and that access token 640 may be provided to Set 616 such that one or more resources in set 616 (e.g., node 618 associated with resource identifier 789) may be accessible to the user that generated permission request 604.

In this example, permission requirements 638 have been provided to caller environment 610, which provide authentication requirements for access types that relate to the nodes in Set 616. For example, a determination may be made in caller environment 610, and specifically by graph data storage set type 1 612 and one or more computing devices associated therewith, that user ID 123 606 has credentials for accessing one or more resources associated with graph data storage set type 1 612 represented by set 616. Those credentials may be determined to correspond to read and write role access types for one or more resources, such as the resource associated with node 618 in Set 616, and the access token 640 including those authentication requirements may therefore be generated and provided to Set 616 such that queries and requests to access resources represented in Set 616 (e.g., node 618) may be accepted and provided back to the user that generated permission request 604.

FIG. 7A is an exemplary method 700A for performing internal authorization of a request to access one or more resources associated with a shared graphical dataset and one or more nodes representing the one or more resources.

The method 700A begins at a start operation and continues to operation 702A where a resource access request is received by a Set representing one or more resources and/or resource relationships associated with the resource access request. According to one example, an access token comprising a unique user identifier and a target Set to be accessed may be received by the target Set. According to other examples, the access token may comprise one or more of a unique user identifier, one or more unique resource identifiers corresponding to the one or more resources that a user is attempting to request, an authorization identifier, and a clearance level identifier associated with the user making the request.

From operation 702A flow continues to operation 703A where an authorization Uri associated with the Set for accessing one or more resource container associated with the resource request may be utilized in providing information from the resource request to the one or more resource container.

From operation 703A flow continues to operation 704A where a determination is made as to an access type for the requested resource based on the request. For example, access token may provide a unique identifier for a resource or resource container that is associated with an access control list comprising one or more access control entries (i.e., elements in an access control list that control or monitor access to an object by a specified trustee) which include criteria that the provided access token may be matched against to determine whether access may be provided to one or more requested resources associated with the access token, and to what degree or access type/role those access types correspond to (e.g., read, write, execute).

Moving from operation 704A flow continues to operation 706A where determined access type information determined at operation 704A is sent back to the Set and corresponding access to one or more nodes in the Set related to the resource for which access has been requested is provided. For example, the information provided by the access token may be matched against a corresponding access control list for a resource that is requested to be accessed, and a determination may be made that one or more access types are authenticated based on that information matching information in the access control list. Upon determining that one or more access types is granted based on matching information from the access token to an access control list for the resource or resource container, the authenticated information may be provided to the Set corresponding to the resource that the request for access is associated with, and one or more access types may be granted based on that authentication information.

From operation 706A flow continues to operation 708A where the access token may be cached for processing subsequent requests to access a specific node associated with the access token and/or one or more Sets associated with the specific node.

From operation 708A flow continues to an end operation and the method 700A ends.

FIG. 7B is an exemplary method 700B for performing external authentication of a request to access one or more resources associated with a shared graphical dataset and one or more nodes representing the one or more resources.

The method 700B begins at a start operation and continues to operation 702B where a request to access a resource is received. For example, a request to access a node associated with a resource, as well as the relationships that may be associated with that node and its corresponding resource attributes may be provided to an identity provider, such as an application database and/or one or more caller applications associated with an application database. The identity provider may provide a permission request to one or more Sets associated with the resource that access is being requested in order to determine what authorization requirements may be required to authenticate access to the requested resource (or nodes associated with the requested resource). For example, a permission request including a user identifier and a resource identifier (or resource container identifier) may be sent from an identity provider to one or more Sets for which the resource identifier corresponds to.

From operation 702B flow continues to operation 704B where a Set associated with the resource is queried for permission requirements related to one or more nodes associated with the resource. For example, a Set associated with the requested resource may receive the permission request and a determination may be made as to what authentication requirements of a node representing that resource and/or the Set as a whole, are necessary for authenticating access to the requested resource request, as well as to the authentication requirements that are necessary for authenticating certain role types that are associated with accessing the resource via the Set.

From operation 706B flow continues to operation 708B where an access token is generated. For example, the identity provider may receive permission requirements for the requested resource access and the identity provider may query an application dataset that hosts the requested resource to determine whether a user or user computing device associated with the requesting user has access to the hosted resource. If credentials for the requesting user and/or user computing device are determined to meet the permission requirements for the requested resource, a user access token may be generated that includes access information for a node representing the requested resource and/or one or more Sets that contain node attributes related to that requested resource.

From operation 708B flow continues to operation 710B where the access token is provided to the Set. For example, an access token including a user identifier, an identifier for a shared graphical dataset, and one or more authorized access types corresponding to the requested resource and/or one or more Sets that contain node attributes related to the requested resource may be provided to the Set.

Moving from operation 710B flow continues to operation 712B where access to the resource is provided to the user based on the Set receiving an access token that meets the permission criteria that was sent to the identity provider.

From operation 712 B From flow continues to operation 714B where the access token may be cached for processing subsequent requests to access a specific node associated with the access token and/or one or more Sets associated with the specific node.

From operation 714B flow continues to an end operation and the method 700B ends.

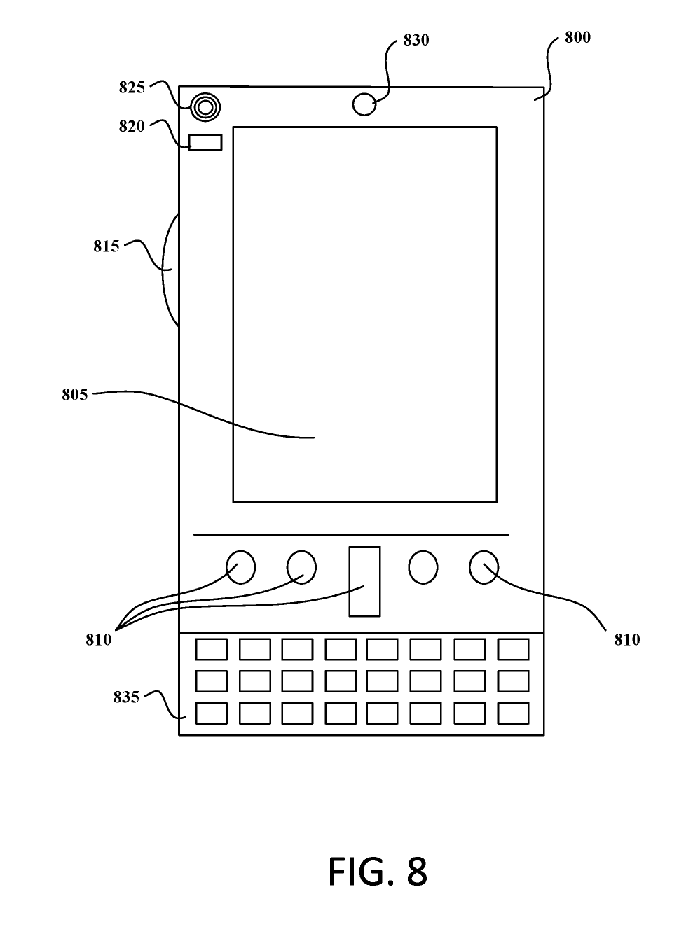

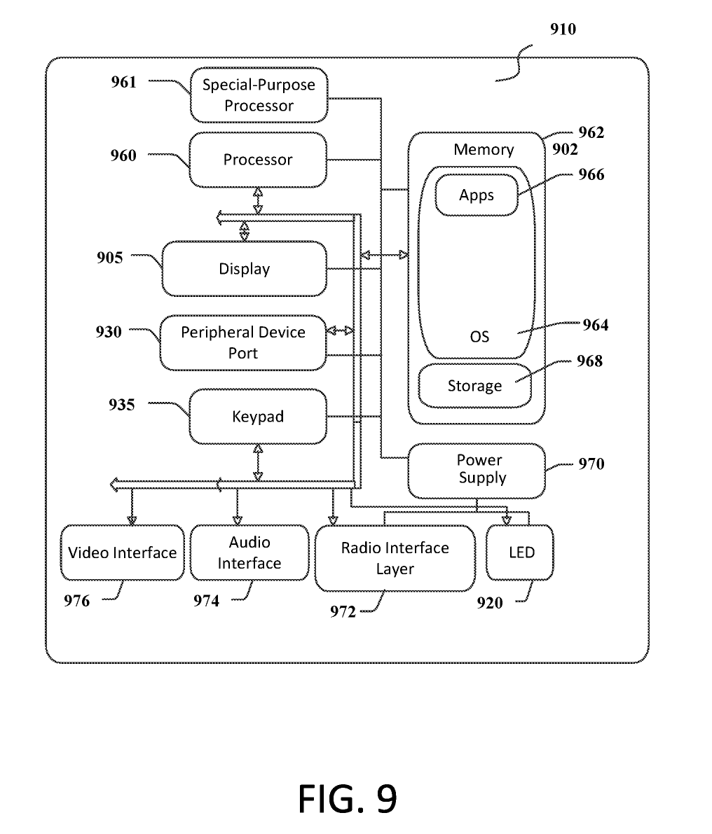

FIG. 8 and FIG. 9 illustrate computing device 800, for example, a mobile telephone, a smart phone, a tablet personal computer, a laptop computer, and the like, with which embodiments of the disclosure may be practiced. With reference to FIG. 8, an exemplary mobile computing device 800 for implementing the embodiments is illustrated. In a basic configuration, the mobile computing device 800 is a handheld computer having both input elements and output elements. The mobile computing device 800 typically includes a display 805 and one or more input buttons 810 that allow the user to enter information into the computing device 800. The display 805 of the mobile computing device 800 may also function as an input device (e.g., a touch screen display). If included, an optional side input element 815 allows further user input. The side input element 815 may be a rotary switch, a button, or any other type of manual input element.

In alternative embodiments, mobile computing device 800 may incorporate more or less input elements. For example, the display 805 may not be a touch screen in some embodiments. In yet another alternative embodiment, the mobile computing device 800 is a portable phone system, such as a cellular phone. The mobile computing device 800 may also include an optional keypad 835. Optional keypad 835 may be a physical keypad or a “soft” keypad generated on the touch screen display.

In various embodiments, the output elements include the display 805 for showing a graphical user interface (GUI), a visual indicator 820 (e.g., a light emitting diode) and/or an audio transducer 825 (e.g., a speaker). In some embodiments, the mobile computing device 800 incorporates a vibration transducer for providing the user with tactile feedback. In yet another embodiments, the mobile computing device 800 incorporates input and/or output ports, such as an audio input (e.g., a microphone jack), an audio output (e.g., a headphone jack), and a video output (e.g., a HDMI port) for sending signals to or receiving signals from an external device. In embodiments, the authentication application may be displayed on the display 805.

FIG. 9 is a block diagram illustrating the architecture of one embodiment of a mobile computing device. That is, the mobile computing device 900 can incorporate a system (i.e., an architecture) 902 to implement some aspects of the disclosure. In one aspect the system 902 is implemented as a “smart phone” capable of running one or more applications (e.g., browser, e-mail, calendaring, contact managers, messaging clients, games, and media clients/players). In some aspects, the system 902 is integrated as a computing device, such as an integrated personal digital assistant (PDA) and a wireless phone.

One or more application programs 966 may be loaded into the memory 962 and run on or in association with the operating system 964. Examples of the application programs include phone dialer programs, e-mail programs, personal information management (PIM) programs, word processing programs, spreadsheet programs, Internet browser programs, messaging programs, diagramming applications, and so forth. The system 902 also includes a non-volatile storage area 968 within the memory 962. The non-volatile storage area 968 may be used to store persistent information that should not be lost if the system 902 is powered down. The application programs 966 may use and store information in the non-volatile storage area 968, such as e-mail or other messages used by an e-mail application, and the like.

A synchronization application (not shown) also resides on the system 902 and is programmed to interact with a corresponding synchronization application resident on a host computer to keep the information stored in the non-volatile storage area 968 synchronized with corresponding information stored in the host computer. As should be appreciated, other applications may be loaded into the memory 962 and run on the mobile computing device 900, including steps and methods for providing access to one or more shard graphical datasets and one or more nodes associated with one or more requested resources associated with those graphical datasets.

The system 902 has a power supply 970, which may be implemented as one or more batteries. The power supply 970 might further include an external power source, such as an AC adapter or a powered docking cradle that supplements or recharges the batteries.

The system 902 may also include a radio 972 that performs the functions of transmitting and receiving radio frequency communications. The radio 972 facilitates wireless connectivity between the system 902 and the “outside world,” via a communications carrier or service provider. Transmissions to and from the radio 972 are conducted under control of the operating system 964. In other words, communications received by the radio 972 may be disseminated to the application programs 966 via the operating system 964, and vice versa. The radio 972 allows the system 902 to communicate with other computing devices such as over a network. The radio 972 is one example of communication media. Communication media may typically be embodied by computer readable instructions, data structures, program modules, or other data in a modulated data signal, such as a carrier wave or other transport mechanism, and includes any information deliver media. The term “modulated data signal” means a signal that has one or more of its characteristics set or changed in such a manner as to encode information in the signal. By way of example, not limitation, communication media includes wired media such as a wired network or direct-wired connection, and wireless media such as acoustic, RF infrared and other wireless media. The term computer readable media is used herein includes both storage media and communication media.

This embodiment of the system 902 provides notifications using the visual indicator 820 that can be used to provide visual notifications and/or an audio interface 974 producing audible notifications via the audio transducer 825. In the illustrated embodiment, the visual indicator 820 is a light emitting diode (LED) and the audio transducer 825 is a speaker. These devices may be directly coupled to the power supply 970 so that when activated, they remain on for a duration dictated by the notification mechanism even though the processor 960 and other components might shut down for conserving battery power. The LED may be programmed to remain on indefinitely until the user takes action to indicate the powered-on status of the device. The audio interface 974 is used to provide audible signals to and receive audible signals from the user. For example, in addition to being coupled to the audio transducer 825, the audio interface 974 may also be coupled to a microphone to receive audible input, such as to facilitate a telephone conversation. In accordance with embodiments of the present invention, the microphone may also serve as an audio sensor to facilitate control of notifications, as will be described below. The system 902 may further include a video interface 976 that enables an operation of an on-board camera 830 to record still images, video stream, and the like.

A mobile computing device 900 implementing the system 902 may have additional features or functionality. For example, the mobile computing device 900 may also include additional data storage devices (removable and/or non-removable) such as, magnetic disks, optical disks, or tape. Such additional storage is illustrated in FIG. 9 by the non-volatile storage area 968. Computer storage media may include volatile and nonvolatile, removable and non-removable media implemented in any method or technology for storage of information, such as computer readable instructions, data structures, program modules, or other data.

Data/information generated or captured by the mobile computing device 900 and stored via the system 902 may be stored locally on the mobile computing device 900, as described above, or the data may be stored on any number of storage media that may be accessed by the device via the radio 972 or via a wired connection between the mobile computing device 900 and a separate computing device associated with the mobile computing device 900, for example, a server computer in a distributed computing network, such as the Internet. As should be appreciated such data/information may be accessed via the mobile computing device 900 via the radio 972 or via a distributed computing network. Similarly, such data/information may be readily transferred between computing devices for storage and use according to well-known data/information transfer and storage means, including electronic mail and collaborative data/information sharing systems.

One of skill in the art will appreciate that the scale of systems such as system 902 may vary and may include more or fewer components than those described in FIG. 9. In some examples, interfacing between components of the system 902 may occur remotely, for example where components of system 902 may be spread across one or more devices of a distributed network. In examples, one or more data stores/storages or other memory are associated with system 902. For example, a component of system 902 may have one or more data storages/memories/stores associated therewith. Data associated with a component of system 902 may be stored thereon as well as processing operations/instructions executed by a component of system 902.

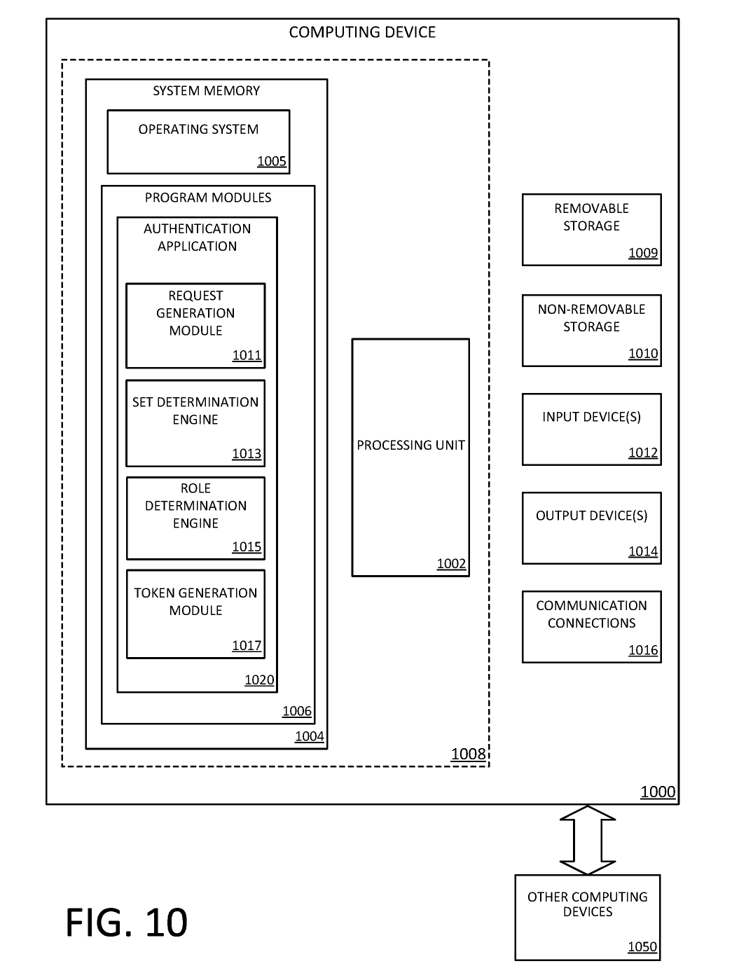

FIG. 10 is a block diagram illustrating physical components (e.g., hardware) of a computing device 1000 with which aspects of the disclosure may be practiced. The computing device components described below may have computer executable instructions for receiving a request to access a resource associated with at least one of the one or more shared graphical datasets, wherein the request comprises a user identifier, a resource identifier, and an authorization URI; determining whether an authorization element for the resource provides one or more access types for the resource based on the user identifier and the authorization URI; and providing access to the resource, based on the user identifier and the authorization URI, for each of the one or more access types that the authorization element is determined to provide access to. The computing device components described below may additionally or alternatively have computer executable instructions for requesting, by a caller application, permission information for a user, wherein the permission information comprises one or more authorized access types for at least one of the shared graphical datasets; receiving the permission information for the user; generating a token for the user, wherein the token comprises a user identifier, an identifier for the shared graphical dataset, and one or more authorized access types that the user has for the graphical dataset; and providing the token to the at least one shared graphical dataset.

In a basic configuration, the computing device 1000 may include at least one processing unit 1002 and a system memory 1004. Depending on the configuration and type of computing device, the system memory 1004 may comprise, but is not limited to, volatile storage (e.g., random access memory), non-volatile storage (e.g., read-only memory), flash memory, or any combination of such memories. The system memory 1004 may include an operating system 1005 and one or more program modules 1006 suitable for authentication application 1020, such as one or more components in regards to FIG. 10 and, in particular, request generation module 1011, set determination engine 1013, role determination engine 1015 and token generation module 1017. For example, request generation module 1011 may configured to receive a user request to access one or more nodes associated with a graphical dataset and request permission information related to one or more Sets associated with one or more resources for that request. Set determination engine may be configured to analyze one or more Sets and determine whether one or more nodes associated with those Sets correspond to a resource access request. Role determination engine 1015 may perform operations related to determining, based on an access token, what access types a user has for a particular resource hosted by an application database. Token generation module may perform operations related to generation of an access token for a Set based on permission requirements of that Set and/or one or more nodes in that Set.

The operating system 1005, for example, may be suitable for controlling the operation of the computing device 1000. Furthermore, aspects of the disclosure may be practiced in conjunction with a graphics library, other operating systems, or any other application program and is not limited to any particular application or system. This basic configuration is illustrated in FIG. 10 by those components within a dashed line 1008. The computing device 1000 may have additional features or functionality. For example, the computing device 1000 may also include additional data storage devices (removable and/or non-removable) such as, for example, magnetic disks, optical disks, or tape. Such additional storage is illustrated in FIG. 10 by a removable storage device 1009 and a non-removable storage device 1010.

As stated above, a number of program modules and data files may be stored in the system memory 1004. While executing on the processing unit 1002, the program modules 1006 (e.g., set combination application 1020) may perform processes including, but not limited to, the aspects, as described herein.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 10 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 900 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 1000 may also have one or more input device(s) 1012 such as a keyboard, a mouse, a pen, a sound or voice input device, a touch or swipe input device, etc. The output device(s) 1014 such as a display, speakers, a printer, etc. may also be included. The aforementioned devices are examples and others may be used. The computing device 1000 may include one or more communication connections 1016 allowing communications with other computing devices 1050. Examples of suitable communication connections 1016 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1004, the removable storage device 1009, and the non-removable storage device 1010 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1000. Any such computer storage media may be part of the computing device 1000. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The different aspects described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

As stated above, a number of program modules and data files may be stored in the system memory 1004. While executing on processing unit 1002, program modules (e.g., applications, Input/Output (I/O) management, and other utilities) may perform processes including, but not limited to, one or more of the operational stages of the methods described herein.

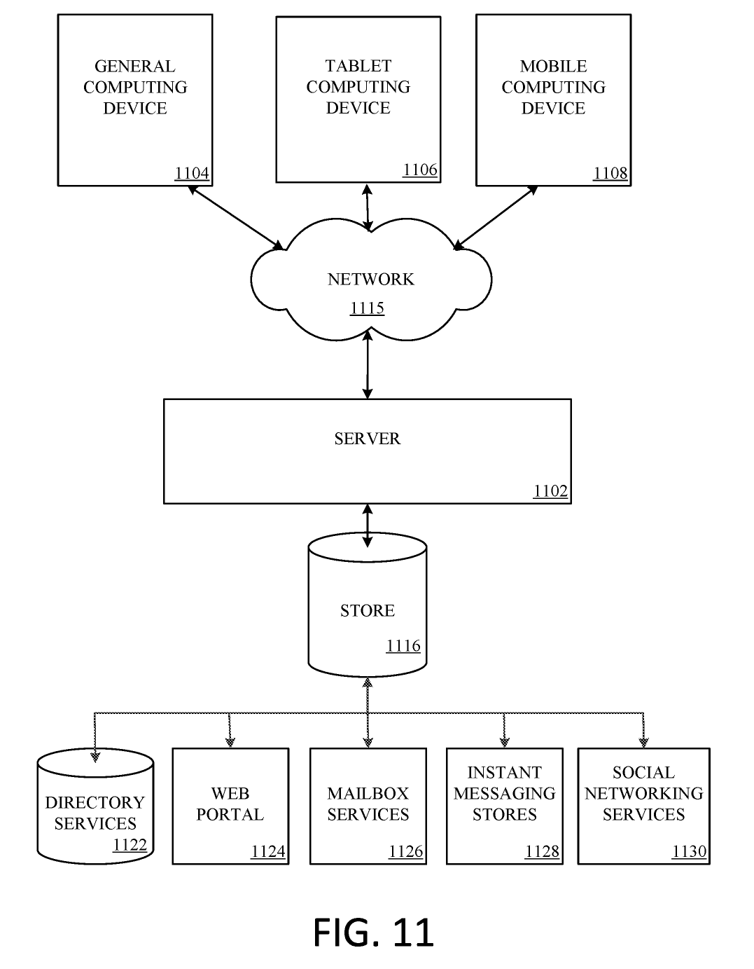

FIG. 11 illustrates one example of the architecture of a system for providing access to one or more nodes associated with a shared graphical dataset as described herein. User input may be accessed, interacted with, or edited in association with programming modules 1006 and storage/memory which may be stored in different communication channels or other storage types. For example, various documents may be stored using a directory service 1122, a web portal 1124, a mailbox service 1126, an instant messaging store 1128, or a social networking site 1130, application 1006, an I0 manager, other utilities and storage systems may use any of these types of systems or the like for enabling data utilization, as described herein. A server 1102 may provide a storage system for use by a client operating on a general computing device 1104 and mobile computing devices 1106 through network 1115.

According to examples, one or more resource may be received on general computing device 1104 and a query for information related to those resources and their corresponding graphical node set or subsets may be provided via one or more mobile computing device 1106. One or more Sets or subsets may be stored on server 1102 and relationships amongst nodes may be identified by processing performed by server 1102. According to additional examples, network 1115 may comprise the Internet or any other type of local or wide area network, and client nodes may be implemented as a computing device embodied in a personal computer, a tablet computing device 1106, and/or by a mobile computing device 1108 (e.g., mobile processing device). Any of these examples of the computing devices described herein may obtain content from the store 1116.

As will be understood from the foregoing disclosure, one aspect of the technology relates to a method for providing access to one or more nodes associated with a shared graphical dataset, comprising: receiving a request to access a resource associated with at least one of the one or more shared graphical datasets, wherein the request comprises a user identifier, a resource identifier, and an authorization URI; determining whether an authorization element for the resource provides one or more access types for the resource based on the user identifier and the authorization URI; and providing access to the resource, based on the user identifier and the authorization URI, for each of the one or more access types that the authorization element is determined to provide access to. In another example an authorization element is an access control entry of an access control list for the resource. According to another example, the one or more access types for the resource comprise: a read role, a write role, and an execute role. In another example, a plurality of nodes associated with the one or more graphical datasets that have one or more resource roles that are authorized based on the request are queried in determining whether to provide the requested access to the resource. In other examples, the method may further comprise determining that the resource has a clearance level authorization element associated with it; and providing access to the resource at an access level authorized by the user identifier and the authorization URI. According to additional examples, information associated with the determination that one or more of the access types for the resource have been authorized based on the user identifier and the authorization URI is cached for processing a subsequent request to access the resource. In still further examples, the cached associated information expires after a temporal threshold has been met.

In another aspect, the technology relates to a method for providing access to one or more nodes associated with a shared graphical dataset, comprising: receiving, by the shared graphical dataset, a request to access one or more resources associated with the shared graphical dataset; providing, by the shared graphical dataset, permission information associated with the request, wherein the permission information comprises a resource container Uri and an authUri; receiving role type and clearance type authorization information based on the provided permission information; and providing access to the graphical dataset corresponding to the received role type and clearance type authorization information.

In another example, the method may include encrypting the permission information with a public key for the caller application. In other examples, the permission information may be provided to a resource container for an application dataset via an authorization URI referencing the resource container. In some examples, the clearance type authorization information may provide role-based access to the one or more resources associated with the one or more graphical datasets. In other examples, the role type authorization information may comprise one or more or a read role access type, a write role access type, and an execute role access type. In yet other examples, a token associated with the provided access to the graphical dataset corresponding to the received role type and clearance type authorization information may be cached by the at least one shared graphical dataset for processing a subsequent request.

In another aspect, the technology relates a system for providing access to one or more nodes associated with a shared graphical dataset, comprising: a memory for storing executable program code; and a processor, functionally coupled to the memory, the processor being responsive to computer-executable instructions contained in the program code and operative to: receive a request to access a resource associated with at least one of the one or more shared graphical datasets, wherein the request comprises a user identifier, a resource identifier, and an authorization URI; determine whether an authorization element for the resource provides one or more access types for the resource based on the user identifier and the authorization URI; and provide access to the resource, based on the user identifier and the authorization URI, for each of the one or more access types that the authorization element is determined to provide access to. In some examples, the authorization element is an access control entry of an access control list for the resource. According to examples, the one or more access types for the resource comprise: a read role, a write role, and an execute role. In other examples, a plurality of nodes associated with the one or more graphical datasets that have one or more resource roles that are authorized based on the request are queried in determining whether to provide the requested access to the resource. In other examples, the processor is further responsive to the computer-executable instructions and operative to: determine that the resource has a clearance level authorization element associated with it; and provide access to the resource at an access level authorized by the user identifier and the authorization URI. In yet other examples, information associated with the determination that one or more of the access types for the resource have been authorized based on the user identifier and the authorization URI is cached for processing a subsequent request to access the resource. In another example, the cached associated information expires after a temporal threshold has been met.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

What is claimed is:

1. A method for providing access to one or more nodes associated with a shared graphical dataset, comprising:
receiving a request to access a resource associated with at least one of the one or more shared graphical datasets, wherein the request comprises a user identifier, a resource identifier, and an authorization URI;
determining whether an authorization element for the resource provides one or more access types for the resource based on the user identifier and the authorization URI; and
providing access to the resource, based on the user identifier and the authorization URI, for each of the one or more access types that the authorization element is determined to provide access to.

2. The method of claim 1, wherein the authorization element is an access control entry of an access control list for the resource.

3. The method of claim 1, wherein the one or more access types for the resource comprise: a read role, a write role, and an execute role.

4. The method of claim 3, wherein a plurality of nodes associated with the one or more graphical datasets that have one or more resource roles that are authorized based on the request are queried in determining whether to provide the requested access to the resource.

5. The method of claim 1, further comprising:
determining that the resource has a clearance level authorization element associated with it; and
providing access to the resource at an access level authorized by the user identifier and the authorization URI.

6. The method of claim 1, wherein information associated with the determination that one or more of the access types for the resource have been authorized based on the user identifier and the authorization URI is cached for processing a subsequent request to access the resource.

7. The method of claim 6, wherein the cached associated information expires after a temporal threshold has been met.

8. A method for providing access to one or more nodes associated with a shared graphical dataset, comprising:
receiving, by the shared graphical dataset, a request to access one or more resources associated with the shared graphical dataset;
providing, by the shared graphical dataset, permission information associated with the request, wherein the permission information comprises a resource container Uri and an authURl;
receiving role type and clearance type authorization information based on the provided permission information; and
providing access to the graphical dataset corresponding to the received role type and clearance type authorization information.

9. The method of claim 8, further comprising encrypting the permission information with a public key for the caller application.

10. The method of claim 8, wherein the permission information is provided to a resource container for an application dataset via an authorization URI referencing the resource container.

11. The method of claim 10, wherein the clearance type authorization information provides role-based access to the one or more resources associated with the one or more graphical datasets.

12. The method of claim 11, wherein the role type authorization information comprises one or more of a read role access type, a write role access type, and an execute role access type.

13. The method of claim 8, wherein a token associated with the provided access to the graphical dataset corresponding to the received role type and clearance type authorization information is cached by the at least one shared graphical dataset for processing a subsequent request.

14. A system for providing access to one or more nodes associated with a shared graphical dataset, comprising:
a memory for storing executable program code; and
a processor, functionally coupled to the memory, the processor being responsive to computer-executable instructions contained in the program code and operative to:
receive a request to access a resource associated with at least one of the one or more shared graphical datasets, wherein the request comprises a user identifier, a resource identifier, and an authorization URI;
determine whether an authorization element for the resource provides one or more access types for the resource based on the user identifier and the authorization URI; and
provide access to the resource, based on the user identifier and the authorization URI, for each of the one or more access types that the authorization element is determined to provide access to.

15. The system of claim 14, wherein the authorization element is an access control entry of an access control list for the resource.

16. The system of claim 14, wherein the one or more access types for the resource comprise:
a read role, a write role, and an execute role.

17. The system of claim 16, wherein a plurality of nodes associated with the one or more graphical datasets that have one or more resource roles that are authorized based on the request are queried in determining whether to provide the requested access to the resource.

18. The system of claim 14 wherein the processor is further responsive to the computer-executable instructions and operative to:
determine that the resource has a clearance level authorization element associated with it; and
provide access to the resource at an access level authorized by the user identifier and the authorization URI.

19. The system of claim 14, wherein information associated with the determination that one or more of the access types for the resource have been authorized based on the user identifier and the authorization URI is cached for processing a subsequent request to access the resource.

20. The system of claim 19, wherein the cached associated information expires after a temporal threshold has been met.
